(19) United States
(12) Patent Application Publication
(10) Pub. No.: US 2014/0261368 A1
(43) Pub. Date: Sep. 18, 2014

(54) BANDSAW CUTTING APPARTUS AND METHOD FOR CUTTING INGOT

(71) Applicant: SHIN-ETSU HANDOTAI CO., LTD., Tokyo (JP)

(72) Inventor: Kazuya Nakagawa, Sabae-shi (JP)

(21) Appl. No.: 14/351,942

(22) PCT Filed: Oct. 15, 2012
(86) PCT No.: PCT/JP2012/006576

§ 371 Date: Apr. 15, 2014

(30) Foreign Application Priority Data
Nov. 24, 2011 (JP) 2011-256654

(51) Int. Cl. B28D 1/08

(52) U.S. Cl. CPC B28D 1/08
USPC 125/21

(57) ABSTRACT

The present invention provides a bandsaw cutting apparatus including an actuator configured to move static pressure pads forward and backward in a rotating direction of a blade, and a controller configured to control a movement distance and a movement speed of the static pressure pads to be moved by the actuator, wherein the ingot is cut by feeding the blade relatively downward toward and below the ingot while a rotating blade is guided with static pressure pads, and the movement of the static pressure pads is controlled with the controller. The apparatus can stably suppress a displacement of the blade during cutting, thereby cutting the ingot into blocks or sample wafers for crystal quality evaluation stably with good quality cut surface at a higher cutting rate and extending the lifetime of the blade.

### TECHNICAL FIELD

The present invention relates to a bandsaw cutting apparatus for cutting an ingot, particularly produced by the Czochralski method (CZ method) and a method for cutting an ingot.

### BACKGROUND ART

Ingots, such as silicon ingots, produced by the CZ method, include a cylindrical body and cone-shaped ends: a top portion and a tail portion. In processes of ingots, these cone-shaped ends are cut and separated from the cylindrical body, and the cylindrical body are then cut into multiple blocks as occasion demands. Each of the blocks is sliced into wafers in a successive process.

Slicers with inner or outer circumferential edges have been used in cutting processes of the cone-shaped ends and of the body into blocks. As the diameter of wafers increases in recent years, bandsaw cutting apparatus is increasingly used for such cutting processes (See Patent Document 1, for example).

An outline of a method of cutting an ingot into blocks with a conventional bandsaw cutting apparatus is illustrated in FIG. 3.

As illustrated in FIG. 3, a bandsaw cutting apparatus 101 is provided with a cutting table 105 for supporting an ingot 104 at the time of cutting. The ingot 104 is horizontally placed on the cutting table 105 before cutting. The bandsaw cutting apparatus 101 is also provided with a belt blade 102 in the form of an endless loop in a tensioned state between pulleys 103 and 103′, and the belt blade includes a blade-abrasive-grain portion at which abrasive grains of diamond are bonded to the periphery of a thin blade base.

Before cutting, the position of the ingot 104 is adjusted such that the position of the blade 102 corresponds to a cutting position of the ingot 104. The blade 102 is then rotated by rotation of the pulleys 103 and 103′, and the blade 102 is fed relatively downward toward and below the ingot 104 to cut the ingot 104.

As such a cutting process is continually repeated, some diamond abrasive grains are covered with powdery particles that are produced by cutting and accumulated on the blade-abrasive-grain portion, or worn or fallen off by cutting so that the cutting capability of the blade decreases.

Thus, variation in cutting capability occurs between both sides of the blade, resulting in a displacement of the blade in a direction of a higher cutting capability side during cutting of the ingot. Each ingot to be cut has a specific direction in which the ingot is readily cut due to its crystal orientation. The blade tends to proceed in this specific direction, resulting in a displacement of the blade in an axial direction of the ingot.

The blade of a bandsaw cutting apparatus recently used becomes thinner to reduce stock removals of cutting of ingots and hence to improve production yield. The displacement frequently occurs among such thin blades.

The displacement of the blade causes inferior quality: steps and chips in a cut surface; significant warp in sample wafers sliced for crystal quality evaluation; severe cut-surface distortion in wafers, and equipment faulty: reduction in lifetime of the blade due to damage of the blade base; breakage of the blade.

As illustrated in FIG. 3, the bandsaw cutting apparatus 101 is accordingly provided with static pressure pads 106 and 106′ in front of and behind a cutting position of the ingot 104 in a rotating direction of the blade 102 to suppress the displacement of the blade 102. The static pressure pads 106 and 106′ include a pair of pad members, each having an outlet, to interpose the blade therebetween, and guide the blade by spraying coolant through the outlets of the pad members to the respective sides of the blade to prevent the displacement of the blade in an axial direction of the ingot during cutting.

### CITATION LIST

### Patent Literature

Patent Document 1: Japanese Unexamined Patent Application Publication No. 2009-154346

### SUMMARY OF INVENTION

### Technical Problem

Unfortunately, a bandsaw cutting apparatus provided with such static pressure pads cannot always cut an ingot while suppressing the displacement of the blade stably between the start of and the end of cutting, and may let a large displacement of the blade to occur during cutting, resulting in the steps and chips in the cut surface and the warp in sample wafers sliced for crystal quality evaluation. This leads to problems of reduction in the production yield and the lifetime of the blade. The large displacement of the blade disadvantageously prevents a cutting rate from being increased.

The present invention has been made in view of the problems, and its object is to provide a bandsaw cutting apparatus and a method for cutting an ingot that can stably suppress the displacement of the blade during cutting, thereby cutting an ingot into blocks or sample wafers with good quality cut surface at a higher cutting rate and extending the lifetime of the blade.

### Solution to Problem

To attain the above-described object, the present invention provides a bandsaw cutting apparatus comprising: a cutting table for horizontally placing an ingot thereon; a belt blade disposed in a tensioned state between pulleys, the belt blade being an endless loop and being configured to rotate by rotation of the pulleys to cut the ingot; static pressure pads disposed in front of and behind a cutting position of the ingot in a rotating direction of the blade, the static pressure pads being configured to spray coolant from both sides of the blade such that the blade is guided to prevent a displacement of the blade in an axial direction of the ingot during cutting; an actuator configured to move the static pressure pads forward and backward in the rotating direction of the blade; and a controller configured to control a movement distance and a movement speed of the static pressure pads to be moved by the actuator, the bandsaw cutting apparatus feeding the blade relatively downward toward and below the ingot while guiding the rotating blade with the static pressure pads and controlling the movement of the static pressure pads with the controller to cut the ingot.

Such a bandsaw cutting apparatus can control distances between the ingot and the respective static pressure pads and a distance between the static pressure pads during cutting according to a position at which the ingot is cut, thereby suppressing the displacement of the blade stably. The apparatus can thus ensure good quality of the cut surface and extend the lifetime of the blade while cutting the ingot at a higher cutting rate.

The movement of the static pressure pads during cutting of the ingot is preferably controlled such that the static pressure pads move along a side face of the ingot.

Such an apparatus can more surely suppress the displacement of the blade stably.

Furthermore, the present invention provides a method for cutting an ingot, comprising: horizontally placing an ingot on a cutting table; disposing a belt blade in a tensioned state between pulleys, the belt blade being an endless loop and being configured to rotate by rotation of the pulleys to cut the ingot; disposing static pressure pads in front of and behind a cutting position of the ingot in a rotating direction of the blade, the static pressure pads being configured to spray coolant from both sides of the blade such that the blade is guided to prevent a displacement of the blade in an axial direction of the ingot during cutting; and feeding the blade relatively downward toward and below the ingot while guiding the rotating blade with the static pressure pads and moving the static pressure pads forward and backward in the rotating direction of the blade to cut the ingot.

Such a method enables adjustment of distances between the ingot and the respective static pressure pads and a distance between the static pressure pads during cutting according to a position at which the ingot is cut, thereby suppressing the displacement of the blade stably. The method thus enables good quality of the cut surface to be ensured while the ingot is cut at a higher cutting rate, and the lifetime of the blade to be extended.

The static pressure pads are preferably moved along a side face of the ingot during cutting of the ingot.

Such a method more surely enables the displacement of the blade to be suppressed stably.

### Advantageous Effects of Invention

In the present invention, the bandsaw cutting apparatus cuts an ingot while controlling movement of static pressure pads forward and backward in a rotating direction of a blade with a controller, thereby appropriately controlling distances between the ingot and the respective static pressure pads and a distance between the static pressure pads during cutting according to a position at which the ingot is cut, thereby suppressing the displacement of the blade stably. The present invention can thus ensure good quality cut surfaces and extend the lifetime of the blade with a higher cutting rate.

### BRIEF DESCRIPTION OF DRAWINGS

FIG. 1A is a schematic perspective view of an exemplary bandsaw cutting apparatus of the present invention;

FIG. 1B is a schematic top view of the apparatus in FIG. 1A;

FIG. 2 is an explanatory view of an example of a method of moving static pressure pads during cutting in the inventive bandsaw cutting apparatus and the inventive method for cutting an ingot; and

FIG. 3 is a schematic diagram of a conventional bandsaw cutting apparatus.

### DESCRIPTION OF EMBODIMENTS

Hereinafter, embodiments of the present invention will be described, but the present invention is not limited thereto.

In general, a bandsaw cutting apparatus, for cutting an ingot, includes static pressure pads to suppress the displacement of a blade. Even such a bandsaw cutting apparatus cannot completely prevent a large displacement of the blade during cutting of an ingot. The displacement causes problems: lower cutting precision, lower quality of cut surfaces, reduction in the lifetime of the blade, being unable to cut the ingot at a higher cutting rate. Accordingly, there is a need for suppressing the displacement of the blade stably throughout cutting.

The inventor repeatedly studied to solve such problems, and found that the displacement of the blade cannot be suppressed stably because the static pressure pads are configured to guide the blade at a fixed position throughout cutting. The inventor then considered that the displacement of the blade can be suppressed stably by moving the static pressure pads forward and backward in a rotating direction of the blade while controlling the position of the static pressure pads. The inventor also studied the configuration of an apparatus for carrying out this method, and thereby brought the present invention to completion.

A bandsaw cutting apparatus of the present invention will now be described.

As illustrated in FIG. 1, the bandsaw cutting apparatus 1 of the present invention includes a cutting table 5 for horizontally placing an ingot 4 thereon, a belt blade 2 in the form of an endless loop for cutting the ingot 4, pulleys 3 and 3′ configured to rotate the blade 2, and static pressure pads configured to guide the blade 2 so as to prevent the displacement of the blade 2 in an axial direction of the ingot 4 during cutting. The static pressure pads may be composed of carbon, for example.

The belt blade 2 includes a blade-abrasive-grain portion at which abrasive grains of diamond are bonded to the periphery of a thin blade base. The grain size of the blade-abrasive-grain portion may be a size of #120 to #220, the width of the blade base may be 60 mm, and the thickness of the blade base may be 0.1 to 0.7 mm, but the present invention is not limited thereto.

The pulleys 3 and 3′ are rotatable about their respective rotating shafts, and disposed such that the rotating shafts are perpendicular to a central axis of the ingot 4 horizontally placed on the cutting table 5. The belt blade 2 in the form of an endless loop are disposed in a tensioned state between the pulleys 3 and 3′ with its blade-abrasive-grain portion facing downward. The blade 2 rotates along with rotation of the pulleys 3 and 3′.

The pulleys may be configured to apply one shaft drive in which any one of the two pulleys 3 and 3′ can be driven to rotate by itself or two shaft drive in which both pulleys can be driven to rotate by itself.

The blade 2 may be stretched at a tension of 1 ton or more between the pulleys 3 and 3′, but this is not limited in particular. Stretching the blade 2 at a tension of 1 ton or more between the pulleys 3 and 3′ prevents the blade 2 from shaking during the rotation of the blade 2 regardless of a rotating direction, even for the one shaft drive.

The cutting table 5 includes a movement mechanism for corresponding a position at which the ingot 4 is cut to the position of the blade 2.

The static pressure pads 6 and 6′ are configured to guide the blade so as to prevent the displacement of the blade in an axial direction of the ingot 4 during cutting, and each include a pair of pad members. Each of the pad members is provided with an outlet through which coolant is sprayed. The static pressure pads 6 and 6′ are disposed so as to interpose the blade by the pair of pad members. The coolant is sprayed through the outlets of the static pressure pads 6 and 6 to the respective side surfaces of the blade during cutting of the ingot to suppress the displacement of the blade 2 by static pressure of the sprayed coolant and also to remove clogging of the blade-abrasive-grain portion and heat produced by cutting.

As illustrated in FIG. 1B, a displacement sensor 11 for measuring the displacement of the blade 2 may be provided.

As illustrated in FIGS. 1A and 1B, the static pressure pads 6 and 6′ are disposed between the ingot 4 and the respective pulleys 3 and 3′, that is, in front of and behind a cutting position, at which the ingot 4 is cut, in the rotating direction of the blade 2.

As illustrated in FIG. 1A, the bandsaw cutting apparatus of the present invention is also provided with actuators 7 and 7′ and a controller 8.

The actuators 7 and 7′ are configured to move the static pressure pads 6 and 6′ forward and backward in the rotating direction of the blade 2 and may include a linear motion guide (a LM guide) or a ball screw, for example. The controller 8 is configured to control a movement distance and a movement speed of the static pressure pads 6 and 6′ to be moved by the actuators 7 and 7′ and may include a servo motor, for example.

With such an inventive bandsaw cutting apparatus 1, the ingot 4 is horizontally placed on the cutting table 5, the blade 2 is rotated by rotation of the pulleys 3 and 3′, and the blade 2 is fed relatively downward toward and below the ingot 4 while the rotating blade 2 is guided with the static pressure pads 6 and 6′ to cut the ingot 4. During the cutting of the ingot 4, the actuators 7 and 7′ move the respective static pressure pads 6 and 6′, and the controller 8 controls the movement of the static pressure pads 6 and 6′, that is, the position of the static pressure pads 6 and 6′.

Such an inventive bandsaw cutting apparatus can control distances between the ingot and the respective static pressure pads and a distance between the static pressure pads during cutting according to a position at which the ingot is cut, thereby suppressing the displacement of the blade stably throughout the cutting.

More specifically, as illustrated in FIG. 2, the movement of the static pressure pads may be controlled such that the static pressure pads 6 and 6′ move along a side face of the ingot 4 along with the progress of cutting. The numeral 9′ in FIG. 2 represents the shape of the side face of the ingot 4, and the numeral ‘10’ represents a movement trajectory of the static pressure pad 6′. As illustrated, the movement may be controlled such that the distances d and d′ between the side face of the ingot 4 and the respective static pressure pads 6 and 6′ are kept constant during cutting. Besides, the movement of the static pressure pads 6 and 6′ is preferably controlled such that the distance d and the distance d′ are identical so that the displacement of the blade is more stably suppressed.

The apparatus can thus more surely suppress the displacement of the blade stably by the control of the movement of the static pressure pads during cutting.

Alternatively, the movement of the static pressure pads may be controlled according to variation in cut resistance due to variation in ingot diameter at the cutting portion along with the progress of cutting. The distances d and d′ from the static pressure pads 6 and 6′ may be reduced when a central portion of the ingot, which has the largest cut resistance, is cut. This control may also be combined with the above control of moving the static pressure pads along the side face of the ingot. Alternatively, the distances d and d′ may be varied by the controller between a side on which the blade enters the ingot and a side on which the blade leaves the ingot.

Next, a method for cutting an ingot of the present invention will be described. The method described herein uses the handsaw cutting apparatus 1 of the present invention as illustrated in FIG. 1.

The belt blade 2 in the form of an endless loop, for cutting an ingot 4, is disposed in a tensioned state between the pulleys 3 and 3′. The static pressure pads 6 and 6′ are disposed in front of and behind the cutting position of the ingot 4 in the rotating direction of the blade 2. As described above, the static pressure pads 6 and 6′ are configured to spray coolant from both sides of the blade 2 such that the blade 2 is guided to prevent the displacement of the blade 2 in an axial direction of the ingot 4 during cutting.

The ingot 4 is then horizontally placed on the cutting table 5 and positioned with the movement mechanism of the cutting table 5 such that a position at which the ingot 4 is cut corresponds to the position of the blade 2. The blade 2 is then rotated by rotation of the pulleys, and the blade 2 is fed relatively downward toward and below the ingot 4 while the rotating blade 2 is guided with the static pressure pads 6 and 6′. The ingot 4 is cut while the static pressure pads 6 and 6′ are moved forward or backward in the rotating direction of the blade 2.

Such an inventive method enables adjustment of distances between the ingot and the respective static pressure pads and a distance between the static pressure pads during cutting according to a position at which the ingot is cut, thereby suppressing the displacement of the blade stably throughout cutting of the ingot.

As illustrated in FIG. 2, the static pressure pads 6 and 6′, similarly with the above apparatus, may be specifically moved along the side face of the ingot 4, particularly such that the distances d and d′ between the side face of the ingot 4 and the respective static pressure pads 6 and 6′ are kept constant. Besides, the static pressure pads 6 and 6′ are preferably moved such that the distance d and the distance d′ are identical.

Such a method enables the displacement of the blade to be more surely suppressed stably.

Alternatively, the static pressure pads, similarly with the above apparatus, may be moved such that the distance between the static pressure pads are varied according to variation in cut resistance due to variation in ingot diameter at the cutting portion along with the progress of the cutting, for example.

Other cutting conditions may be the same as conventional conditions. The speed at which the blade is fed relatively downward (the cutting rate) may be 25 to 30 mm/min, and the coolant may be sprayed under a pressure of 0.1 to 0.4 MPa with a flow rate of 300 to 2000 cc/min, for example.

In the bandsaw cutting apparatus and the method for cutting an ingot of the present invention, feeding the blade relatively downward toward and below the ingot means feeding the blade downward toward and below the ingot, or feeding the ingot upward toward and above the blade, or the combination thereof.

### Example

The present invention will be described below more specifically with an example and a comparative example of the present invention, but the present invention is not limited to this example.

### Example

A 300-mm-diameter silicon single crystal ingot was cut into sample wafers with the inventive bandsaw cutting apparatus as illustrated in FIG. 1 in accordance with the inventive method for cutting an ingot to measure the displacement of the blade during the cutting and to evaluate a failure rate of cut sample wafers and the lifetime of the blade. Here, the failure rate was represented by a proportion in which the size of warp occurring in the wafers exceeded a threshold due to a large displacement of the blade, and the lifetime of the blade was represented by the number of cutting.

Cutting conditions were as follows: The thickness of the blade base of the blade was 0.5 mm; the feeding speed (the cutting rate) of the blade was 27 mm/min; and the coolant was sprayed under a pressure of 0.2 MPa at a flow rate of 2000 cc/min. As illustrated in FIG. 2, the static pressure pads were moved along the side face of the ingot during cutting such that the distances d and d′ between the side face of the ingot and the respective static pressure pads were kept a constant of 30 mm, and the distances d and d′ were identical.

As a result, the displacement of the blade was suppressed to 100 μm or less throughout the cutting in Example, whereas the displacement unstably varied between 200 to 300 μm in the later-described Comparative Example. The failure rate of the cut sample wafers was 2%, which was better than 10% in the later-described Comparative Example. The lifetime of the blade was approximately 400 times, which was 1.3 times longer than 300 times in the later-described Comparative Example.

The stable suppression of the displacement of the blade allowed the cutting rate to be improved by about 10%. More specifically, the displacement of the blade was sufficiently stably suppressed at an increased cutting rate of 30 mm/min.

It was thus confirmed that the bandsaw cutting apparatus and the method for cutting an ingot that can stably suppress the displacement of the blade during cutting, thereby ensuring good quality cut surface at a higher cutting rate and extending the lifetime of the blade.

### Comparative Example

An ingot was cut under the same conditions as those of Example except that a conventional bandsaw cutting apparatus as illustrated in FIG. 3, which did not include the actuators and the controller of the inventive bandsaw cutting apparatus, was used and static pressure pads were not moved from the respective fixed positions, and it was evaluated by the same way at Example.

As a result, the displacement of the blade unstably varied between 200 to 300 μm, which was worse than a displacement of 100 μm or less in Example. The failure rate of the cut sample wafers was 10%, which was worse than that in Example. The lifetime of the blade was 300 times, which was shorter than that in Example.

When the ingot was cut while the blade was fed at a feeding speed of 30 mm/min, the displacement of the blade became too large to obtain sample wafers with required quality.

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

1. A bandsaw cutting apparatus comprising:
a cutting table for horizontally placing an ingot thereon; a belt blade disposed in a tensioned state between pulleys, the belt blade being an endless loop and being configured to rotate by rotation of the pulleys to cut the ingot;
static pressure pads disposed in front of and behind a cutting position of the ingot in a rotating direction of the blade, the static pressure pads being configured to spray coolant from both sides of the blade such that the blade is guided to prevent a displacement of the blade in an axial direction of the ingot during cutting;
an actuator configured to move the static pressure pads forward and backward in the rotating direction of the blade; and
a controller configured to control a movement distance and a movement speed of the static pressure pads to be moved by the actuator,
the bandsaw cutting apparatus feeding the blade relatively downward toward and below the ingot while guiding the rotating blade with the static pressure pads and controlling the movement of the static pressure pads with the controller to cut the ingot.

2. The bandsaw cutting apparatus according to claim 1,
wherein the movement of the static pressure pads during cutting of the ingot is controlled such that the static pressure pads move along a side face of the ingot.

3. A method for cutting an ingot, comprising:
horizontally placing an ingot on a cutting table;
disposing a belt blade in a tensioned state between pulleys, the belt blade being an endless loop and being configured to rotate by rotation of the pulleys to cut the ingot;
disposing static pressure pads in front of and behind a cutting position of the ingot in a rotating direction of the blade, the static pressure pads being configured to spray coolant from both sides of the blade such that the blade is guided to prevent a displacement of the blade in an axial direction of the ingot during cutting; and
feeding the blade relatively downward toward and below the ingot while guiding the rotating blade with the static pressure pads and moving the static pressure pads forward and backward in the rotating direction of the blade to cut the ingot.

4. The ingot cutting method according claim 3,
wherein the static pressure pads are moved along a side face of the ingot during cutting of the ingot.
